(19) United States
(12) Patent Application Publication
(10) Pub. No.: US 2005/0021990 A1
(43) Pub. Date: Jan. 27, 2005

(54) Method for making secure a secret quantity

(76) Inventors: Pierre-Yvan Liardet, Peynier (FR); Herve Chabanne, Mantes La Jolie (FR)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 10/488,630

(22) PCT Filed: Sep. 4, 2002
(86) PCT No.: PCT/FR02/03007

(30) Foreign Application Priority Data
Sep. 4, 2001 (FR) 01 11430

(51) Int. Cl. G06F 12/14; H04L 9/00

(52) U.S. Cl. 713/194; 380/2; 380/37

(57) ABSTRACT

The invention concerns a method and a system for making secure a secret quantity, contained in an electronic device, and used at least partly in an encryption algorithm of at least part of an input data executing a predetermined number (N) of successive iterations of a common function and producing at least part of an output data, which consists in: storing (14), after a first number (X) (of iterations, an intermediate result; applying, to the output data, a function inverse to that of the encryption for a number (N−X) of iterations corresponding to the difference between the total number of iterations and the first number, comparing (18) the intermediate result with the result of iterations of the inverse function; and validating the encryption only if the two results are identical.

The present invention relates to the protection of a secret key or datum (generally, a binary word) used in a process of authentication or identification of an electronic device (for example, an integrated circuit of a smart card or an electronic card containing one or several integrated circuits) or the like, against piracy attempts. The present invention more specifically relates to the detecting of an attempt to pirate the secret datum, this detection enabling blocking the component or the process using this secret datum, or simulating a random behavior.

Among attacks intended to determine by piracy the value of a secret quantity, the present invention applies to attacks by differential fault analysis (DFA) of a digital processing circuit exploiting a private or secret datum. Such an attack consists of causing a “fault” or error in the execution, by the component, of a function involving an input datum (readable) and the secret datum, and statistically analyzing the influence of this fault by examining an output datum, to detect the secret datum. Various execution faults can be provoked in the component. For example, the value of an internal register or of a bit taken into account in the calculation may be changed, or the progress of the internal program may be changed by being disturbed, for example, by the acceleration of the execution clock. The instruction counter may, further, be physically modified, etc. Most often, in a DFA attack, the component operation is disturbed with no knowledge of which specific element has been modified.

An example of a cryptography system applied to a DFA and a conventional example of a countermeasure are described in article “Differential Fault Analysis of Secret Key Cryptosystems”, by Eli Biham and Adi Shamir, published in 1997 under references Technion-Computer Science Department Technical Report CS0910.revized.

The present invention more specifically applies to the protection of a secret key or datum involved in an input datum cryptography or encoding algorithm by executing a predetermined number of successive iterations of a same function. For example, the algorithm may be an algorithm of DES (DATA ENCRYPTION STANDARD) type described, for example, in work “Handbook of Applied Cryptography” by A. J. Menezes, P. C. van Oorschot, and S. A. Vanstone, published by CRC Press LLC in 1997, pages 252 -257. In a DES algorithm, an input datum is divided in two parts (the right-hand and left-hand portions of a binary word) to which is applied by successive iterations a same function taking as operands not only the secret datum, but also the portion of the word resulting from the preceding operation, by inverting the considered side (left-hand or right-hand).

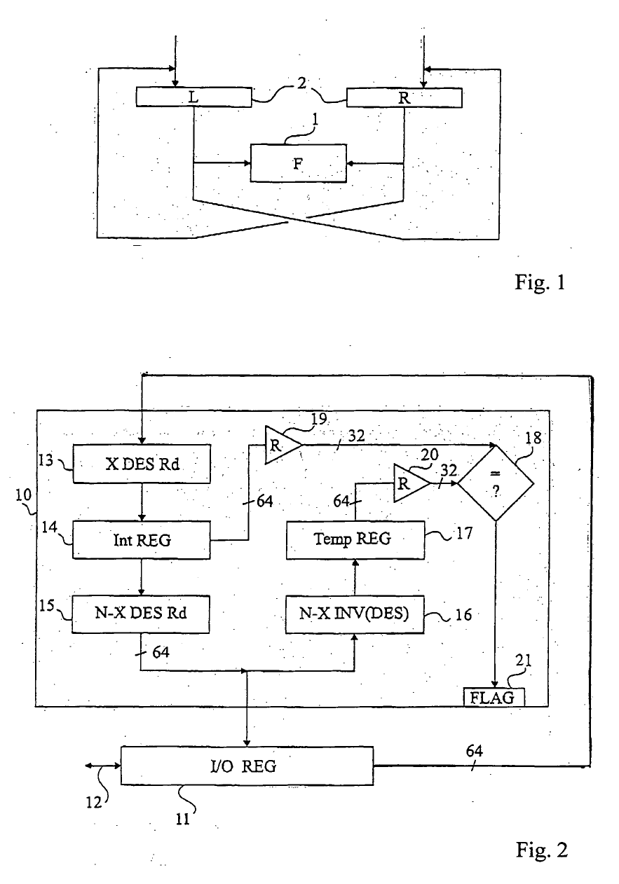

FIG. 1 very schematically illustrates in the form of blocks a conventional example of a DES method. For each iteration, a function (block 1, F) taking into account respectively right-hand (R) and left-hand (L) portions of a word stored in a register 2 is executed. The result of the function is then stored again in register 2, but inverting the respective positions of the right-hand and left-hand portions of the words. The number of iterations is variable. In particular, the DES algorithm performs 16 iterations of function F. To make the encryption and decryption symmetrical, the crossing (inversion of the left-hand and right-hand sides of the resulting data) is not performed in the last iteration.

More generally, the present invention applies to any algorithm of encryption by iterations. The functions implemented in each iteration often are simple functions (addition(s), multiplication(s), modular reduction(s), permutation(s), substitution(s), etc.) and the encryption efficiency results from the repeating of these functions on the output data of the preceding iteration.

An attack by differential fault analysis generally consists of intervening on the last iteration of an algorithm (for example, a DES algorithm). Most often, the encryption operation of the last iteration is performed, a first time with no fault and a second time having provoked a fault either in at least one input bit, or in the program clock, or in any ongoing process. The values obtained by a logic addition (XOR) are then combined. By analyzing the results on a great number of operations, the involved secret quantity can be detected. The voluntary error can be introduced at any iteration of the calculation. However, the fault analysis is always performed on the last iteration, which is the only one to be accessible to pirates. Further, in a DES-type algorithm which divides the right-hand and left-hand portions of a register, the search for the key is performed by only examining one portion (generally, the left-hand portion) of the results.

For example, it is assumed that the last iteration (the 16-th) performs, to obtain the left-hand portion L16 of the result, the following operation:
L16=F(R15, K16)⊕L15, where F represents the applied encryption function, where R represents the right-hand portion of the result register (R15 representing its content after the 15-th iteration), where L represents the left-hand portion of the result register (L15 representing its content after the 15-th iteration) and where K represents the sub-key implemented for the corresponding iteration (here, the 16-th).

The operation performed with a provoked fault then is the following:
L16f=F(R15f, K16)⊕L15, where exponent f identifies an erroneous datum (spoiled with a provoked error).

For the search of the key, results L16 and L16f are logically added and the following relation is obtained:
L16 ⊕L16f=F(R15f, K16)⊕F(R15f, K16), in which only secret datum K16 is unknown.

In attacks by introduction of faults, the later the error is introduced in the process (on an intermediary result of high rank), the more the number of faulty messages which are to be analyzed to determine the key (more specifically, the sub-key taken into account in the sixteenth iteration) is reduced. In practice, it can be considered that if the error is introduced before the eighth iteration of a DES algorithm, the time necessary to the collection of the faulty executions and to the automatic execution of the differential analysis becomes too important so that the sub-key cannot be pirated in practice. Since it is not known yet on which iteration rank it is intervened, random attacks are frequently used. In this case, there necessarily are, probabilistically, operations which are performed on the last iterations, whereby the sub-key can statistically be determined.

A first method forming a countermeasure against DFA-type attacks is to duplicate the calculations. By performing each iterative calculation twice, it is considered that it can be determined whether a fault has been introduced in one of the calculations. It is then considered that there are few risks for a same fault to occur twice at the same moment in the calculation.

A disadvantage of this countermeasure method is that it is necessary to reproduce the DES algorithm twice. If said algorithm is performed by software means, this takes time. If it is implemented by hardware means, this takes up space by duplication of the circuits.

Another disadvantage is that it is necessary to store the final and intermediary data in registers to be able to compare the results of the two calculations to detect a possible attack.

Another disadvantage is that it is actually even possible for the same error to be reproduced by the pirate with a non-zero probability.

Other piracy detection methods are known. In particular, countermeasures against attacks by differential power analysis (DPA) are known in the art. Such methods however do not protect against differential fault analysis (DFA).

The present invention aims at providing a novel method for protecting a secret datum against differential fault analysis attacks.

The present invention more specifically aims at providing a protection method which does not require doubling the iterative algorithm which is desired to be protected.

The present invention also aims at providing a particularly reliable method which especially enables avoiding the risk of seeing two consecutive errors appear.

The present invention further aims at providing a protection method which takes up little space on the integrated circuit and little calculation time with respect to the actual encryption algorithm.

To achieve these objects as well as others, the present invention provides a method for protecting a secret quantity, contained in an electronic device, and used at least partly in an algorithm of encryption of at least a portion of an input datum executing a predetermined number of successive iterations of a same function and generating at least a portion of an output datum, including the steps of:
storing, after a first number of iterations, an intermediary result;
applying, to the output datum, a function which is the inverse of that of the encryption for a number of iterations corresponding to the difference between the total number of iterations and the first number;
comparing the intermediary result with the result of the iterations of the inverse function; and
only validating the encryption if said two results are compatible.

According to an embodiment of the present invention, the comparison is performed after application of a combination function and/or of an expansion function and/or of an arithmetical function, to the intermediary results.

According to an embodiment of the present invention, the comparison of the intermediary and inverse function results only takes part of the data into account.

According to an embodiment of the present invention, the time interval between the obtaining of the result of the encryption algorithm and of the implementation of the iterations of the inverse function is made random.

According to an embodiment of the present invention, the protection method is applied to the detection of a attempt of piracy by differential fault analysis.

According to an embodiment of the present invention, the number of iterations before storage of the intermediary result is a function of the probability of discovering the secret quantity according to the iteration at which an error is introduced.

According to an embodiment of the present invention, the protection method is implemented by hardware means.

According to an embodiment of the present invention, the protection process is implemented by software means.

According to an embodiment of the present invention, the intermediary result is only stored for the duration necessary to its comparison with the result of the iterations of the inverse function.

The present invention also provides a circuit of encryption of an input datum by means of at least one secret datum.

The foregoing objects, features and advantages of the present invention will be discussed in detail in the following non-limiting description of specific embodiments in connection with the accompanying drawings, in which:

FIG. 1, previously described, very schematically shows an iteration of a conventional DES method of the type to which the present invention applies; and

FIG. 2 illustrates in the form of block diagrams an embodiment of the protection method of the present invention in hardware form.

For clarity, only those steps of the method and those components of a protection cell which are necessary to the understanding of the present invention have been shown in the drawings and will be described hereafter. In particular, the actual function implemented by the encryption algorithm which is desired to be protected has not been detailed and may be any function. Further, the details of the DES method to which the present invention more specifically applies are well known and can be found in literature.

A feature of the present invention is to store, upon execution of the encryption method, an intermediary calculation result corresponding to the result of the algorithm after a predetermined number of iterations. Another feature of the present invention is, at the end of the algorithm, to apply on a number of iterations which is a function of the number of iterations of the intermediary result, an inverse function based on the final result. The storage of the intermediary result enables comparing this result with that obtained upon application of the iterations of the inverse function. If the results are identical, it can be considered that the circuit has not been the object of a piracy attempt or that the provoked error is not exploitable by the pirate.

FIG. 2 illustrates, in the form of block diagrams, a cell 10 of encryption of an integrated circuit according to the present invention. The example of FIG. 2 concerns the implementation of a DES-type encryption method such as described hereabove. It should however be noted that the present invention more generally applies to any encryption algorithm executing a predetermined number of successive iterations of a same function.

A message M to be encrypted is, conventionally, introduced in an input/output register 11 (I/O REG) by a bus 12 communicating with the other conventional circuits of the integrated circuit (not shown). Register 11 is intended to contain, at the end of the encryption, encrypted message C. The number of bits of messages M and C depends on the application. For example, in a DES-type method, messages M and C are generally over sixty-four bits. The sixty-four bits of message M are sent to the input of encryption cell 10. In the example of FIG. 2, the case of a cell formed by hardware means has been considered. As an alternative, the encryption algorithm may be exclusively implemented by software means.

At the input of the encryption cell, after having initialized, in a default state, a validation bit (block 21, FLAG) which will be described hereafter, a predetermined number X of iterations of the algorithm is first executed (block 13, X DES Rd). The function implemented at each iteration may correspond to any function of a conventional encryption algorithm. For example, said function is function F of a DES-type algorithm such as illustrated in FIG. 1. The result of the X iterations corresponds to the intermediary result of the present invention, stored in a dedicated register (block 14, INT REG). The storage in the intermediary register is preferentially temporary, that is, the register will be deleted once the comparison with the result of the application of the inverse function, as will be seen hereafter, is performed. The encryption algorithm is ended by executing the N−X remaining iterations (block 15, N−X DES Rd), where N represents the total number of iterations of the encryption algorithm (16 for a DES algorithm). The sixty-four bits resulting from the application of the algorithm are, conventionally, provided to input/output register 11 and correspond to message C.

According to the present invention, N−X iterations of the inverse function of the encryption algorithm are applied to this message (block 16, N−X INV(DES)) to recover the intermediary value stored in register 14. The result of the N−X inverse iterations is stored in a second temporary register (block 17, TEMP REG). Then, the respective contents of registers 14 and 17 are compared (block 18, =?) to check whether they are identical. Preferably, the comparison is performed on a portion only of the messages contained in registers 14 and 17. In particular, in the context of a DES-type method, the only right-hand or the left-hand portions of the messages are preferentially compared. Indeed, due to the successive inversions of the right-hand and left-hand portions at each iteration of the encryption algorithm, such a comparison is sufficient. In this case, the outputs of registers 14 and 17 over sixty-four bits cross selection gates, respectively 19 and 20, to only provide thirty-two bits to comparator 18. As an alternative, gates 19 and 20 execute any function, provided that it is a “free collision” function, that is, that a modification of an input bit is enough to modify the output.

According to a preferred embodiment of the present invention, the encryption cell provides a validation bit (block 21, FLAG) which, by default, is in a state indicative of an error (piracy attempt). Only if comparator 18 provides a result corresponding to an identity between the intermediary and inverse function results (or a compatibility between these results if they transit through a function) does validation bit 21 switch to the other state. Results are compatible if, as they are applied to a same function (combination, parity bit calculation, CRC, chopping function, etc.), they provide equal results. The state of the validation bit is used, for example, to authorize the provision of the message contained in register 11 on input/output bus 12. Any other use of the validation bit may be devised. For example, said bit may be used to inhibit other functions of the integrated circuit as long as an authentication is not considered as valid. A random result may also be provided, in case of a detected piracy, to vitiate the differential fault analysis.

An advantage of the present invention is that it makes piracy by differential error analysis more difficult, by making the reproduction of a same error to be taken into account by the encryption algorithm more difficult. Indeed, conversely to conventional solutions consisting of performing twice the same error at the same time in the development of the encryption algorithm, such a reproduction is made almost impossible by the fact that the checking is performed on an inverse function. Accordingly, by causing an error, be it in the X first iterations or in the N−X remaining iterations of the function, a same error reproduced at the beginning of the inverse function will not provide the same results. This result makes the method of the present invention robust, even for errors presented to randomly selected iterations.

According to a preferred embodiment, the execution of the N−X iterations of the inverse function of the encryption algorithm is postponed with a random delay from the obtaining of the result stored in the input/output register. The reproducibility of a fault at a same step of the encryption algorithm is thus made even less probable.

The choice of number X of iterations determining the intermediary stored result depends on the application and on the encryption algorithm used. In the example of a DES-type algorithm of sixteen iterations, it is preferentially chosen to stored an intermediary result after eight iterations. This choice is linked to the fact that, statistically, the encryption key cannot be obtained by analysis of the results of the eight first iterations. Indeed, if an error is introduced during the eight first iterations, the analysis of the result of the encrypted message will not enable obtaining the encryption key in an economically viable time (generally estimated to a few month of collection of faulty data and of automatic calculation by a computer). Accordingly, the pirate reading from the intermediary register does not weaken the system. If the error is introduced between the ninth and sixteenth iterations (block 15, FIG. 2), the possible pirate cannot reproduce the same error at the same time in the application of the inverse function on iterations 16 to 9 (block 16). This results in that the validation bit (block 21) remains in an error state.

In an encryption algorithm providing no inversion or mixing of the bits of the intermediary results according to the iterations, the comparison will preferentially be performed on all the message bits to avoid missing the detection of an error if said error has occurred on a non-compared bit. However, in methods performing an inversion of portions of the messages upon each iteration, as is the case for the DES algorithm, it is possible to only compare a portion of the messages. Indeed, the probability of not detecting an attack by introduction of an error then is negligible and considerable time is gained on the comparison operation.

Of course, the present invention is likely to have various alterations, modifications, and improvements which will readily occur to those skilled in the art. In particular, it may be chosen or not to perform a number of operations in parallel. For example, if the encryption algorithm is implemented by hardware means, the read/write times in the registers may be used to perform in parallel certain calculations, especially, certain iterations of the inverse function of the encryption algorithm.

Further, the practical implementation of the present invention and its adapting to a conventional algorithm of encryption by successive iterations is within the abilities of those skilled in the art based on the functional indications given hereabove, be it for a software or hardware implementation. Function F and the inversions of FIG. 1 correspond, in this example, to one of the N iterations.

Further, the present invention applies whether the secret datum is used in all or part of each iteration.

Finally, the method of the present invention is compatible with conventional methods that includes countermeasures against attacks by differential power analysis.

1. A method for protecting a secret quantity, contained in an electronic device, and used at least partly in an algorithm of encryption of at least a portion of an input datum executing a predetermined number of successive iterations of a same function and generating at least a portion of an output datum, characterized in that it includes the steps of:
storing, after a first number of iterations, an intermediary result;
applying, to the output datum, a function which is the inverse of that of the encryption for a number of iterations corresponding to the difference between the total number of iterations and the first number;
comparing the intermediary result with the result of the iterations of the inverse function; and
validating the encryption only if said results are compatible.

2. The method of claim 1, wherein the comparison is performed after application of a combination function and/or of an expansion function and/or of an arithmetical function, to the intermediary results.

3. The method of claim 1, wherein the comparison of the intermediary and inverse function results only takes part of the data into account.

4. The method of claim 1, wherein the time interval between the obtaining of the result of the encryption algorithm and of the implementation of the iterations of the inverse function is made random.

5. The method of claim 1, wherein the protection method is applied to the detection of a attempt of piracy by differential fault analysis.

6. The method of claim 5, wherein the number of iterations before storage of the intermediary result is a function of the probability of discovering the secret quantity according to the iteration at which an error is introduced.

7. The method of claim 1, implemented by hardware means.

8. The method of claim 1, implemented by software means.

9. The method of claim 1, wherein the intermediary result is stored only for the duration necessary to its comparison with the result of the iterations of the inverse function.

10. A circuit of encryption of an input datum by means of at least one secret datum, including means for implementing the protection method of claim 1.
